(19) United States
(12) Patent Application Publication
(10) Pub. No.: US 2001/0044988 A1
(43) Pub. Date: Nov. 29, 2001

(54) Door opening device, in particular for an electric household appliance door

(76) Inventor: Claudio Buscella, Gassino Torinese (IT)

Correspondence Address: LOWE HAUPTMAN GILMAN & BERNER, LLP, Suite 310, 1700 Diagonal Road, Alexandria, VA, 22314, US

(21) Appl. No.: 09/827,363

(22) Filed: Apr. 6, 2001

(30) Foreign Application Priority Data
Apr. 7, 2000 (IT) MI200 A 000759

(51) Int. Cl. B62B 1/00

(52) U.S. Cl. 16/412

(57) ABSTRACT

A device for opening a door, in particular an electric household appliance door, wherein a handle and a catch for engaging a respective seat are formed in a one-piece body from polymer material; and an elastic contrasting member, acting on the catch and defined, for example, by a metal plate, is also co-molded in a one-piece body with the handle and the catch, so that the device according to the invention has fewer component parts to assemble as compared with known devices.

The present invention relates to a door opening device, in particular for an electric household appliance door.

### BACKGROUND OF THE INVENTION

Devices for opening electric household appliance, in particular washing-machine, doors are known to comprise a number of assembled components, typically: a handle gripped by the user and hinged by pins to the door; a catch fixed to and movable with the handle to engage a seat formed on the appliance; and a contrasting spring acting on the catch to keep it in the closed position while at the same time permitting release of the catch from the seat.

The major drawback of devices of this sort is the number of separate components for assembly, which obviously affects overall cost.

### SUMMARY OF THE INVENTION

It is an object of the present invention to provide an opening device designed to eliminate the aforementioned drawbacks of known devices, and which, in particular, has a small number of components for assembly, is therefore cheap and easy to produce, and at the same time is both efficient and reliable.

According to the present invention, there is provided a device for opening a door, in particular an electric household appliance door, the device comprising a handle; a catch for engaging a respective seat; elastic contrasting means acting on said catch; and hinge means permitting rotation of said handle with respect to the door and, consequently, release of said catch from the respective seat; and being characterized in that said handle is formed in a one-piece body with said catch from polymer material; and in that said elastic means are defined by an elastic member projecting integrally from said handle and said catch.

The opening device according to the invention therefore has fewer components to assemble than known devices, is therefore cheaper and easier to produce and install, and is nevertheless highly efficient and reliable.

### BRIEF DESCRIPTION OF THE DRAWINGS

A non-limiting embodiment of the present invention will be described by way of example with reference to the accompanying drawings, in which:

FIG. 1 shows a schematic view in perspective of an opening device in accordance with the invention being assembled to the respective door;

FIG. 2 shows a partly sectioned longitudinal view of the FIG. 1 device;

FIGS. 3 and 4 show plan and front views respectively of the FIG. 1 device (off the door).

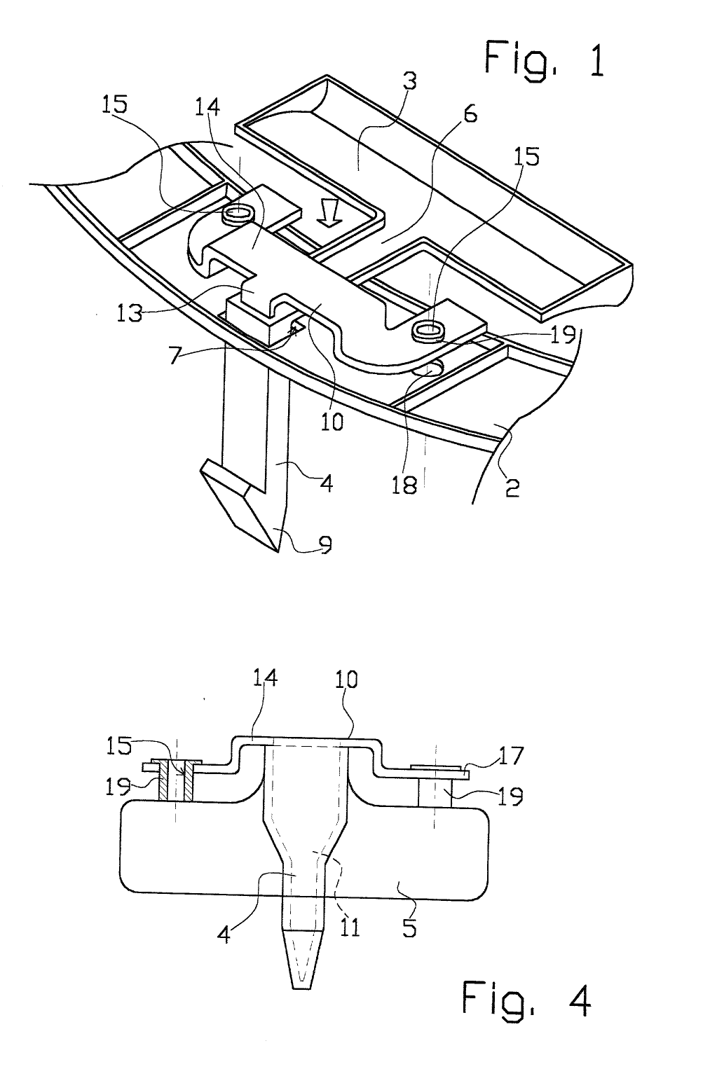

### DETAILED DESCRIPTION OF THE INVENTION

Number 1 in the accompanying drawings indicates as a whole a device for opening a door 2, e.g. a known door (not shown in detail for the sake of simplicity) of a known washing-machine. Device 1 comprises a handle 3; and a catch 4 for engaging in known manner a seat formed on the known washing-machine (not shown). In the example shown, handle 3 is substantially T-shaped, and comprises a grip portion 5 and a substantially perpendicular connecting portion 6 for connecting the grip portion to catch 4. Catch 4 is defined by a bar projecting perpendicularly from the end of connecting portion 6 opposite grip portion 5, is inserted loosely through an opening 7 in door 2, and has a retaining tooth 9 on the free end 8.

According to the invention, handle 3 is formed in a one-piece body with catch 4 from polymer material, and device 1 also comprises an elastic contrasting member 10 acting on catch 4 and projecting integrally from the one-piece body defined by handle 3 and catch 4. In a preferred embodiment, elastic member 10 is co-molded in a one-piece body with handle 3 and catch 4, and is defined by a contoured metal plate comprising a first portion 11 inserted inside catch 4 and embedded in the polymer material of catch 4 to form a reinforcing core of the catch, and a second portion 12 joined integrally to portion 11 and projecting outwards of catch 4. Portion 12 of elastic member 10 projects from the end of catch 4 opposite free end 8 supporting retaining tooth 9, and has an L-shaped bend 13 bent 90° towards grip portion 5; and, on the opposite side to portion 11, elastic member 10 has a substantially T-shaped end portion 14 with fastening means 15 (of any known type) for connection to door 2.

In one variation, elastic member 10 defined by the metal plate only comprises portions 12 and 13, and is connected to and projects from catch 4 in any known manner (e.g. is clicked inside a seat on catch 4) so that end portion 14 with fastening means 15 may be formed, e.g. co-molded, in one piece with the one-piece body defined by handle 3 and catch 4.

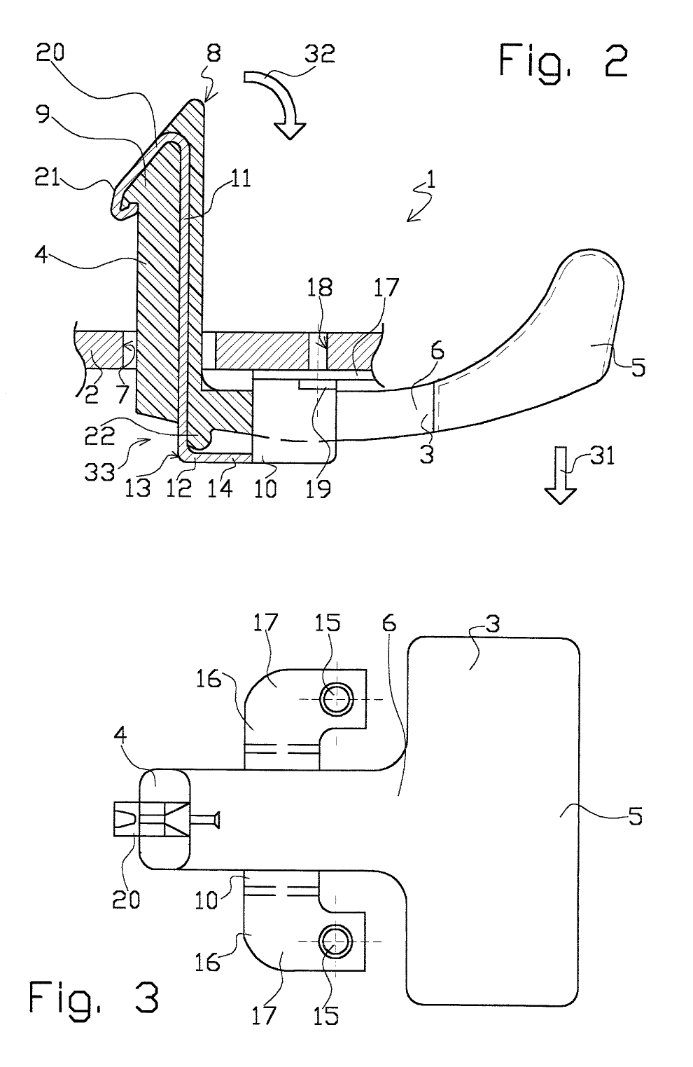

In the non-limiting example shown, T-shaped end portion 14 comprises two opposite aligned arms 16 terminating with respective plates 17 having through holes 15 aligned with respective threaded seats 18 formed in door 2 to receive respective screws and defining respective fastening points by which to fasten device 1 to door 2. Each plate 17 is bent 90° to respective arm 16 and is connected to it by a double S-shaped bend; and holes 15, as opposed to being aligned with bend 13, are offset laterally (FIG. 2) and formed in respective collars 19, which may be applied to or formed, e.g. molded, in one piece with elastic member 10.

At the opposite end to T-shaped end portion 14, elastic member 10 also comprises a head 20, which comes out of free end 8 of catch 4 and has a surface 21 sloping with respect to the longitudinal axis of catch 4 and resting on a corresponding outer front surface of catch 4 facing away from handle 3. Surface 21 of head 20 also extends to cover substantially the whole front surface of retaining tooth 9. Handle 3 comprises a projection 22, preferably with a rounded head and projecting from connecting portion 6 towards portion 12 of elastic member 10 at bend 13, so as to define a flexing point of elastic member 10.

In actual use (FIG. 2 in particular), device 1 is fitted firmly to door 2 by fastening means 15, with catch 4 inserted through opening 7. When the door is closed, catch 4 is secured (in known manner) to the washing-machine by known closing members, and in particular engages the corresponding seat on the washing-machine and is held in position by elastic member 10.

To open door 2, the user acts on grip portion 5 of handle 3 in the direction of arrow 31 in FIG. 2. Being secured to door 2 at the fastening points defined by holes 15, handle 3 flexes so that projection 22 flexes elastic member 10 at bend 13 to rotate catch 4, with respect to the bend point defined by bend 13, in the direction of arrow 32 in FIG. 2 and so release catch 4 from the respective seat to open door 2. Bend 13 of elastic member 10 and projection 22 of handle 3 thus define hinge means 33 permitting rotation of handle 3 with respect to the door and, consequently, release of catch 4 from the respective seat on the door.

To close door 2, the user pushes door 2 towards the washing-machine: on coming into contact with the washing-machine, surface 21 of catch 4 slides on a corresponding contacting member forming part of the closing members of the washing-machine, and at the same time flexes catch 4 in the direction of arrow 32 in FIG. 2 and in opposition to the elastic force exerted by elastic member 10; catch 4 and elastic member 10 therefore both flex together into a deformed position enabling catch 4 to engage its seat; and, once the seat is engaged, catch 4 is restored to and locked in the undeformed position by elastic member 10.

Clearly, changes may be made to the opening device as described and illustrated herein without, however, departing from the scope of the present invention. For example, in one possible variation (not shown, but by now clear to anyone skilled in the art), handle 3, again formed in a one-piece body with catch 4 and elastic member 10, is hinged to door 2 by pins; and elastic member 10 again projects from catch 4 to counteract rotation of handle 3 (and therefore catch 4), but does not comprise end portion 14 with fastening means 15. In this case, too, device 1 provides for reducing the number of component parts with respect to the known state of the art.

1. A device (1) for opening a door (2), in particular an electric household appliance door, the device comprising a handle (3); a catch (4) for engaging a respective seat; elastic contrasting means (10) acting on said catch (4); and hinge means (33) permitting rotation of said handle with respect to the door and, consequently, release of said catch from the respective seat; and being characterized in that said handle (3) is formed in a one-piece body with said catch (4) from polymer material; and in that said elastic means are defined by an elastic member (10) projecting integrally from said handle (3) and said catch (4).

2. A device as claimed in claim 1, characterized in that said elastic member (10) is co-molded in a one-piece body with said handle (3) and said catch (4).

3. A device as claimed in claim 2, characterized in that said elastic member (10) is defined by a contoured metal plate, and comprises a first portion (11) inserted inside said catch (4) and embedded in the polymer material of said catch to form a reinforcing core of said catch.

4. A device as claimed in claim 3, characterized in that said elastic member (10) also comprises a second portion (12) joined integrally to said first portion (11) and extending outside said catch (4) of polymer material to define said hinge means (33).

5. A device as claimed in claim 4, characterized in that said second portion (12) of the elastic member (10) has a bend (13) outside said catch (4); said handle (3) having a projection (22) at said bend (13) and defining a bend point of said elastic member (10).

6. A device as claimed in claim 5, characterized in that said elastic member (10) also comprises an end portion (14) connected integrally to said second portion (12) on the opposite side to said first portion (11); said end portion (14) being substantially T-shaped and having fastening means (15) for connection to said door (2).

7. A device as claimed in claim 6, characterized in that said elastic member (10) also comprises a head (20) at the opposite end to said T-shaped end portion (14); said head (20) projecting from said catch (4) of polymer material. 8) A device as claimed in claim 7, characterized in that said head (20) has a surface (21) sloping with respect to a longitudinal axis of said catch (4) and resting on a corresponding surface of said catch.
